(19) United States
(12) Patent Application Publication
(10) Pub. No.: US 2025/0345843 A1
(43) Pub. Date: Nov. 13, 2025

(54) PRINTABLE CERAMIC COMPOSITIONS FOR ADDITIVE MANUFACTURING OF METAL OBJECTS

(71) Applicant: Magnus Metal Ltd, Revadim (IL)

(72) Inventors: Valeriya Frid ZAID, Tel Aviv-Yafo (IL); Hani FARRAN, Ramat Gan (IL); Roi LEVI, Rehovot (IL)

(73) Assignee: Magnus Metal Ltd, Revadim (IL)

(21) Appl. No.: 18/658,305

(22) Filed: May 8, 2024

(51) Int. Cl. B22C 1/18; B33Y 70/10; C04B 35/488; C04B 35/626; C04B 35/63

(52) U.S. Cl. CPC B22C 1/185; B33Y 70/10; C04B 35/488; C04B 35/62625; C04B 35/6309; C04B 2235/3244; C04B 2235/447; C04B 2235/6026; C04B 2235/9676

(57) ABSTRACT

The present disclosure concerns printable refractory compositions, more particularly ceramic-based pastes for three-dimensional printing of molds for additive metal casting, that are based on inorganic binders having several, temperature dependent polymerization states, to permit improved adhesion between stacked mold regions in an additive printing process utilizing compositions of the present disclosure.

### TECHNOLOGICAL FIELD

The present disclosure concerns printable refractory compositions, more particularly ceramic-based pastes for 3D printing of molds for additive metal casting.

### BACKGROUND ART

References considered to be relevant as background to the presently disclosed subject matter are listed below:
US patent application publication no. 2015/0246387
PCT patent application publication no. WO2019053712
PCT patent application publication no. WO2022243921
PCT patent application publication no. WO2023002468
Chiou et al., Journal of Material Science 1993, 28, 1435-1446
Luz et al., Ceramics International 2016, 42 (7), 8331-8337
Chen et al., Materials Science and Engineering 2003, A348, 29-35
US patent application publication no. 2020/269320
Japanese patent application publication no. 2015532209

Acknowledgement of the above references herein is not to be inferred as meaning that these are in any way relevant to the patentability of the presently disclosed subject matter.

### BACKGROUND

Casting is one of the oldest material-forming methods still used today. The principal process had not changed since 3200 BC when bronze was melted and poured into a stone mold. Metal casting is defined as the process in which molten metal is poured into a mold that contains a hollow cavity of a desired geometrical shape and allowed to cool down to form a solidified part.

Most of the world's demand for metal casts is addressed nowadays by traditional casting techniques. While automation solutions are applied, traditional casting involves the global production of molds and the global application of molten metal. For example, additive manufacturing techniques are used for mold fabrication with the implementation of mold curing, sintering, or otherwise mold curing (partially or fully) as a global operation before metal pouring. Molten metal is poured into fully fabricated molds.

Currently available metal additive manufacturing technologies address complex design and low volume applications of relatively small-size parts. Scaling from small parts to large parts of hundreds and thousands of kilograms is not trivial. In several currently available metal additive manufacturing technologies, size and weight scaling-up involve part deformation, distortion, shrinking, fracture, cracking, and more.

In some technologies for additive manufacturing of metal object, ultra-thin layers of mold composition are deposited. Due to the small dimensions of the layers, production of large metal object is a lengthy and costly process. Such thin layers prevent casting of large volumes of metal in each casting cycle.

Despite the advantages of metal additive manufacturing, the associated high cost, low throughput, and scaling-up challenges prevent the adoption of additive techniques for widespread industrial use, especially for manufacturing iron and steel parts.

Casting is widely used for industrial manufacturing of large production quantities and sizable parts in a one-piece cast. Metal casting can produce complex shapes and features like internal cavities or hollow sections can be easily formed. Materials that are difficult or expensive to manufacture using other manufacturing processes can be cast. Compared to other manufacturing processes, existing casting is cheaper for medium to large metal quantities, especially for iron and steel casting.

Modern metal casting also has several disadvantages. Patterns and molds are time-consuming and expensive to make. Additive manufacturing processes, such as binder jetting, are typically used to create patterns and molds. However, the fabrication of patterns and molds extend the lead time and limit design flexibility for modifications and adaptations. Additionally, minor post-processing or significant additional post-processing operations are needed for certain applications. Furthermore, metal casting is a hazardous activity, as it involves many elements such as furnaces, molds, cooling areas, and additional tooling that are manually operated and exposed, while operating at very high temperatures.

An example of a system and method for additive metal casting is described in PCT patent applications publication numbers WO2019053712A1, WO2023002468 and WO2022243921A1 assigned to the assignee of the present application, which are incorporated herein by reference. The method described therein includes depositing a first portion of a mold (mold region), pouring liquid substance into the first portion of the mold to form a first casted layer (object region), solidifying at least a portion of the first casted layer, depositing a second portion of the mold on top of the first portion of the mold, pouring the liquid substance into the second portion of the mold to form a second casted layer on top of at least a portion of the first casted layer, and solidifying at least a portion of the second casted layer. Thus, in a sequential manner, a stack of production layers is produced on a building table, each production layer is composed of a mold region and an object region. The mold region may be constructed in-situ, by mold paste deposition, or ex-situ, by placing remotely-fabricated mold region frames. The object region is produced by depositing molten metal into the mold region, one production layer after the other.

### GENERAL DESCRIPTION

In the additive casting process, namely in a casting-in-layers process, a metal object region is cast in each production layer by depositing molten metal into a cavity defined by a mold region. A layer of mold paste is first deposited according to a pre-defined pattern to form a mold region, at least partially cured, and then molten metal is cast into the cavity defined by the mold region to obtain the object region laterally encased by the mold region. The deposited metal is then permitted to partially cool and solidify, thereby allowing subsequent deposition of an ensuing layer of mold paste.

Thus, the process includes deposition cycles, in each cycle a mold region and an object region are formed to define together a production layer, followed by subsequent deposition cycles, until the entire desired object is obtained. In other words, a continuous sequence of deposition cycles is carried out, in each cycle a mold region is deposited first, followed by deposition of a metal object region, to obtain a stack of production layers which result in a combined mold-metal layered structure. Further, in order to facilitate bonding between the deposited metal layers, at least some of the already-casted metal object regions at times undergo a pre-deposition heating treatment, to at least partially melt the top surface of the upper-most deposited metal layer, rendering already deposited metal suitable for bonding to the next metal layer to be applied thereonto. Such pre-deposition heating may be carried out, for example, by one or more heating elements that is positioned over the deposition area, and configured to heat the upper production layer(s), and directed to heat the upper-most deposited object region.

Further, in some instances, the metal object regions undergoes post-deposition heating, e.g. for causing stress relaxation within the object region or for causing controlled phase transition within the object region. Such post-deposition heating also exposes the mold region to various temperature profiles and various heat dissipation requirements. The mold region needs to withstand the various temperature shocks and mechanical shocks in order to minimize mechanical failure of the mold region during the additive casting process.

In the additive casting process described herein, the subsequent cycles of mold-object deposition involve repeated exposure to heating cycles. The mold regions, which define the cavities into which the metal is cast, are exposed to a sequence of thermal shocks at various temperature profiles, resulting from the contact with the molten metal and the dissipation of heat into the mold regions during and subsequent the deposition of the object region. Additional thermal shocks may be affected by pre-deposition and post-deposition heating of the deposited metal object regions. Further, as the already-deposited metal expands and contracts with each deposition of a new metal thereonto, the thermal shock cycles are also accompanied by repeated mechanical stressing of the mold regions due to expansion and contraction of the metal due to the rapid changes in temperatures at the metal object region.

Embodiments of the present disclosure are useful for casting metals such as gray iron, ductile iron, steel, Inconel, titanium alloys, cast iron alloys and the like. Preferably, metal solids (powderless, e.g. rods, ingots, billets and the like) are used as input. Iron (as well as iron alloys, such as steel) is commonly used in many industrial applications due to its high strength and durability. However, iron has higher melting points (e.g. compared to aluminum), making it more challenging to process in an additive manufacturing context.

Therefore, there is a need for molds, and hence mold pastes, that can withstand such thermal and mechanical stresses during additive metal deposition in an additive manufacturing process, as to minimize mechanical failure of the mold during mold deposition and also during metal deposition.

While in traditional mold manufacturing techniques, typically based on ceramic compositions, entire molds or mold layers are deposited and then fully sintered before deposition of molten metal, the presently disclosed paste compositions are designed to function as mold regions in a non-sintered state, typically as a green body (as will be further explained below). Designing the paste to form green body mold regions enable significant reduction in production time and energy consumption, as full sintering is not required. However, working at a green body state involves significant challenges such as lower inter-layer adhesion and intra-layer interface strength, lower tensile strength and higher porosity comparing fully-sintered ceramics.

Further, unlike other additive processes, in which thin (or even ultra-thin) layers of mold are formed (for example by binder-jetting mold manufacturing, or additive mold-metal manufacturing as described in US2020269320), the paste compositions of this disclosure are tailored to additive processes of relatively large metal objects, and are hence designed to enable formation of voluminous mold regions. In other words, the paste compositions of this disclosure are designed to be suitable for large scale deposition, forming relatively thick and voluminous mold regions, thereby providing sufficient mechanical support for casting-in-layers of large metal objects and minimizing mechanical failure of the mold regions during the additive casting process.

Working with thick or voluminous mold regions possess several challenges, mostly relating to heat distribution and transfer into the mold region and from the metal region to the mold region, as well as stress loading applied onto the mold region due to repeated expansion of the object region during repeated heating and cooling of the metal therein. Further, working with thicker or more voluminous mold regions requires better control over the surface properties of the mold region, to permit sufficient adhesion of subsequently applied mold regions (to thereby minimize or prevent cracking of the mold at the interface between stacked mold regions).

The pastes of the present disclosure aim at addressing these challenges. The present disclosure provides mold paste compositions suitable for in-situ additive printing of molds, designed for additive casting molten metal to form metal objects by the cycled mold-metal regions deposition methods described herein. The paste compositions are designed to permit not only intra-layer mechanical strength, but also improved inter-layer adhesion between adjacent mold layers, thereby reducing the risk of mechanical failure of the mold due to the aggressive metal-casting conditions and the risk of leakage of the molten metal during additive casting.

It is noted that in the context of the present disclosure, additive metal casting refers to cycles of fabricating production layers. In the context of the present disclosure, the production layer includes one or more mold regions each defining and surrounding a respective metal object region. The mold regions are typically in a closed-loop geometry, each mold region of a production layer defining a cavity into which molten metal is cast to obtain the object region of the production layer. After the stack of production layers is fabricated, a combined mold-metal structure is obtained, following which the mold is removed, e.g. by using known mold removal techniques, and the desired metal object is obtained.

It is to be noted that, typically, the lowermost, base layer of the mold is made solely out of the mold material, and is typically continuous (i.e. without forming a cavity therein), as to form a uniform, continuous base onto which a sequence of production layers is formed. However, it is to be understood that at times, depending on the desired mold geometry, that no such base layer is needed.

Thus, in the description below, the term mold region will refer to the mold part/portion within the single production layer. The mold region in each production layer can be a single monolithic layer formed out of the paste composition. Alternatively, the mold region in a production layer can be formed from a stack of sub-layers, together defining a multi-layered mold region. For example, the mold region a production layer can be composed of several (e.g. 2-5) sub-layers (print-lines) of paste compositions that are continuously deposited one on top of the other in order to form the mold region of the production layer before deposition of the into the cavity defined thereby.

In some configurations, the mold region in each production layer is a single monolithic layer of the paste composition. According to other configurations, the mold region in each production layer comprises at least 2, typically between 2 and 5, sub-layers (print-lines) of the paste composition. According to some other configurations, the mold region in some of the production layers are each a single monolithic layer of the paste composition, while the mold regions in the rest of the production layers are structured from sub-layers of the paste composition.

For illustration, in a specific non-limiting example, molten metal additive casting of gray iron objects in which the paste compositions of this disclosure are used, is formed out of a stack of production layers, each of 2-20 mm height. In an exemplary construction, a production layer can be formed from a mold region of 8 mm height, which can be a monolithic deposition of paste composition in the form of solid paste cylinders with average cross-section of 8 mm; alternatively a mold region of 8 mm height can be constructed by depositing 4 mold sub-layers, each of 2 mm height. The corresponding object region may have the same height-8 mm (or less), and may be fabricated by a single depositing of 8 mm of metal, by several subsequent depositions within a manufacturing cycle of the fabrication layer, e.g. two consecutive depositions of metal, each 4 mm in height. In other words, the mold region in each production layer can be formed out of one or more print lines, defining the height of the mold region in the production layer. The resultant mold region is therefore voluminous to withstand the thermal and mechanical shock exerted by introduction of molten metal into the cavity defined by the mold region, and designed to receive molten metal of a corresponding height.

The terms mold or mold structure will refer to all or part of the stack of mold regions in all or several production layers.

It should be understood that in the general field of mold fabrication by 3D printing, the term “mold” is commonly used to describe a complete mold structure, fully sintered/cured before metal pouring. Unlike 3D techniques known in the art, the paste compositions of the present disclosure are designed for in-situ additive fabrication, namely, production of a stack of fabrication layers, each fabrication layer being produced by a production cycle that comprises deposition of a mold region, followed by deposition of a metal object region. The geometry of the mold regions is dictated by the geometry of metal object region to be cast, according to the geometry of the final metal object to be manufactured. Therefore, the mold regions of different production layers may or may not be of the same size and geometry.

The term metal means to denote any metals and/or mellitic alloys which are suitable for melting and casting, for example, ferrous alloys (gray iron, ductile iron, compacted graphite iron (CGI), steel, titanium, etc.), non-ferrous allows (nickel-chromium-based superalloys, e.g. Inconel), aluminum alloys, copper alloys, nickel alloys, magnesium alloys, and the like.

According to a first aspect, the present disclosure provides a paste composition for manufacturing of a mold in additive casting of a metal object, in a process of subsequent formation of production layers, each production layer comprising at least one mold region and at least one metal object region, each production layer being manufactured by deposition of said paste composition to form said mold region, drying said mold region, and deposition of molten metal into a cavity defined by the mold region to obtain the metal object region,
the paste composition comprising:
at least one refractory ceramic material in particulate form;
at least one carrier liquid; and
at least one inorganic binder having two or more, temperature dependent, polymerization states, a first of said polymerization states being obtained at a lower temperature than a second of said polymerization states,
the inorganic binder being selected to undergo polymerization to said first polymerization state during deposition and/or drying of the mold region, and to said second polymerization state during deposition of said molten metal.

According to another aspect, the disclosure provides a paste composition for manufacturing of a mold for additive casting a metal object, in a process of subsequent formation of production layers, each production layer comprising at least one mold region and at least one metal object region, each production layer being manufactured by deposition of said paste composition to form said mold region, drying said mold region, and deposition of molten metal into a cavity defined by the mold region to obtain the metal object region,
each mold region having an object region-facing surface and a subsequent mold region-facing surface,
the paste composition comprising:
at least one refractory ceramic material in particulate form;
at least one carrier liquid; and
at least one inorganic binder having two or more, temperature dependent, polymerization states, a first of said polymerization states being obtained at a lower temperature than a second of said polymerization states,
the inorganic binder being selected to undergo polymerization to said first polymerization state during deposition and/or drying of the mold region, and to said second polymerization state in the subsequent mold region-facing surface during deposition of said molten metal.

In other words, the paste composition is designed to form a refractory ceramic-based mold region, in which an inorganic binder that has different polymerization states at different temperatures is used. Depending on the temperature to which the binder is exposed to during the production of the production layer, the binder undergoes a change in polymerization states, thereby modifying the mechanical properties of the mold region to suit the specific production stage.

The term polymerization state refers to different crystallographic phases of the inorganic binder, the transition between the different phases being temperature dependent.

The term inorganic binder refers to a non-organic material or composition (i.e. carbon-free) which functions to bind the particles of the refractory ceramic material together at the mold region green state. In other words, the inorganic binder forms a polymeric chain having an inorganic backbone. The binder acts through a combination of cohesive forces within the binder itself and adhesion to the refractory ceramic material particles at the interface between the binder and the particles. As the additive casting of metal in which the paste compositions of this disclosure are utilized requires exposure of the paste composition to high temperatures, inorganic binders are utilized, that can withstand the process temperatures.

The inventors of the presently disclosed technology have come to the surprising understanding that a group of inorganic binders having several (i.e. a plurality of), temperature-dependent, polymerization states, can be effectively utilized in the in-situ formation of mold regions in additive casting of metal objects using molten metal. It was surprisingly found that different stages of polymerization of the paste, tailored compositionally to temperatures of the additive casting process result not only in improved mechanical properties and stability of the mold, but also to significant reduction in overall process time and energy consumption, as will be detailed herein.

By some embodiments, during deposition and/or drying of the mold region in a production layer, the paste composition is exposed to a first temperature to polymerize the binder to said first polymerization state. According to some embodiments, the first polymerization state being obtained at a first temperature ranging between about 80° C. and about 200° C. When in the first polymerization state, the binder is sufficiently polymerized to hold the particles of the refractory ceramic material together and form a solidified state of the paste. Hence, when in the first polymerization state, the paste is sufficiently stable to hold its deposited shape, without substantive sagging, deforming, bending, etc.

By some embodiments, the paste composition undergoes initial physical stabilization, in which the deposited paste is initially stabilized, i.e. maintaining its deposited shape. Such initial physical stabilization, according to some embodiments, occurs at a stabilization temperature of between about 80° C. and about 120° C., followed by transition of the inorganic binder to the first polymerization state at a temperature higher than 120° C.

In addition, it is at time desired to carry out one or more surface treatments of the mold region before casting the molten metal, e.g. to smoothen the surface or to render the mold region with desired surface features, typically in portions of the mold regions that will be interfacing the molten metal (e.g. inner walls of the mold region). For example, such metal-facing surfaces may undergo surface shaping, material removal (e.g. of ceramic sags), surface smoothening, coating, etc. by a variety of processing techniques, such as milling, grinding, polishing, heating, coating and the like. The binder is thus selected, by some embodiments, such that its first polymerization state renders the paste composition in the mold region with sufficient mechanical stability to withstand such surface treatment operations. Such surface treatment can be typically obtained at a mold temperature of between about 160° C. and about 220° C.

Heating to said first temperature in order to obtain said first polymerization state can be carried out continuously (i.e. a continuous gradual increase in temperature from the deposition temperature to the first temperature). Alternatively, the heating to said first temperature can be carried out in intervals, i.e. incremental increase in temperature over defined time intervals, in each time interval a constant temperature being maintained until reaching the first temperature.

As the paste composition is typically designed for commercial, mass production additive casting processes, it is important that each manufacturing step will be time efficient. Depending on the heating technology, geometry of the deposited mold region, and/or working conditions, the time duration to obtain said first polymerization state can be between about 1 second and about 7 days. For example, heating by microwave can permit obtaining said first polymerization state within a few seconds, e.g. about 1-30 seconds. In other exemplary heating technologies, e.g. externally heating by electrical heating bodies, the first polymerization state can be obtained in about 10 seconds to about 20 minutes. In heating by convective heating (e.g. in an oven), the first polymerization state can be obtained within about 1 hour to about 5 days.

Once a first polymerization state is obtained and the paste in the mold region is sufficiently mechanically stable, the molten metal can be applied into the cavity defined by the mold region of the specific production layer which is manufactured. As the molten metal is typically at a temperature significantly higher than said first temperature, the mold region is exposed to the molten metal temperature, e.g. at least 1000° C. (for example 1200° C.-1300° C. for gray iron). While at the immediate interface between the molten metal and the mold region complete polymerization of the binder may occur, other portions of the mold region which are farther from the immediate interface with the metal will be exposed to more moderate temperatures. Hence, the binder is selected such that when exposed to said second temperature, which is higher than said first temperature (however, in some embodiments, may be lower than the temperature of the molten metal), the binder in portions of the mold region that are not at the immediate interface with the metal will be polymerized to said second polymerization state, rendering such portions at a proper polymerization state to ensure adhesion to fresh paste that is to be deposited onto the produced fabrication layer to form the mold region of the ensuing production layer.

Proper adhesion between the mold regions of ensuing production layers is of outmost importance to ensure three-dimensional mold integrity during the repeated thermal shocks and mechanical stresses developing during the additive casting process. The inorganic binder in the paste composition is selected such that once a production layer is fabricated, at least portions of the mold region remain at a proper polymerization state to provide sufficient adhesion of the ensuing mold region deposited thereonto, such that inter-layer cracks or inter-layer mechanical failure is minimized (at times eliminated).

Another importance of sufficient adhesion is the minimization of formation of inter-layer voids between the stacked mold regions, into which molten metal can infiltrate during the metal casting stage. Such infiltrations are undesired, as infiltration of molten metal in between stacked mold regions form mechanical interlocking of the metal with the mold, making it difficult to remove the mold from the metal object, as well as requiring significant post-processing of the metal object after its extraction from the mold. Therefore, maintaining an “active” surface of the mold region after exposure to said second temperature to ensure sufficient binding/adhesion to an ensuing deposited paste is highly significant.

Unlike existing mold manufacturing processes, in which the entire mold is first produced, and typically sintered in order to obtain a rigid ceramic structure prior to casting of the entire metal object into the mold-in the additive casting processes in which the paste compositions of this disclosure are used, the mold region is not exposed to sintering conditions (which require a long exposure to high temperatures). It is to be noted that sintering is typically used in known mold manufacturing processes when thick or voluminous mold regions are formed/deposited in order to provide for a fully sintered mold before introduction of molten metal thereinto. Unlike existing mold manufacturing processes, the paste composition of this disclosure is designed to be deposited as thick or voluminous regions (typically in the form of cylinders having an average diameter of 2-20 mm), without requiring sintering before introduction of molten metal, hence providing mold regions in a green body state. The term green body (or green body state) means to denote a state in which the ceramic particles are held together by the binder, after the binder has gone through at least partial polymerization. Unlike a sintered state, in which the binder is thermally decomposed and the ceramic particles are “fused” to one another to form a continuous, 3-dimensional ceramic structure, in the green body state the ceramic particles are not fused to one another, and hence the mechanical properties of the mold region are determined by the combination of ceramic material and the binder (at its at least partial polymerized state) and the interactions between them. Working at a green body state of the mold region is accompanied by significant reduction in overall energy consumption of the process, as no energy needs to be invested to first obtain a sintered mold region, while also saving significant process time (as typical sintering spans at least several hours).

Changing the polymerization state of the binder by exposure to said second temperature further modifies the mechanical properties of the mold region, rendering it with higher hardness at the outer perimeter of the mold region, in spite being at a green body state, such that the mold region can withstand not only the repeated thermal and mechanical stresses, but also the pressure onto a given mold region by the ensuing deposition of the next mold regions in the ensuing production layers.

According to some embodiments, the second polymerization state is obtained at a second temperature that is higher than 220° C., e.g. a temperature ranging between about 220° C. and about 800° C. By some embodiments, the second polymerization state is obtained substantially within about 1 minute to about 30 minutes when exposed to said second temperature.

Gradual polymerization into different, temperature dependent, polymerization states also assists in minimizing intra-layer cracking and/or mechanical failure. The paste comprises at least one carrier liquid, in which the particles of the refractory ceramic material and the inorganic binder are dispersed in order to obtain a paste consistency.

The liquid carrier is a liquid or a mixture of liquids that permits at least partial wetting and/or at least partial dispersion of the refractory ceramic material, and typically has a boiling temperature of at most about 220° C.

According to some embodiments, the carrier liquid can be selected from water, C₁-C₆ alcohols, C₅-C₁₂ alkanes, mineral oils, natural oil, synthetic oils, and any mixture thereof.

According to some embodiments, the carrier liquid is water. The water can be, for example, tap water, filtered water, distilled water, ionized water, deionized water, sterile water, etc.

During various stages of heating, the carrier liquid boils, resulting in vapors that need to be released from the paste after its deposition as a mold region. Gradual polymerization of the binder allows for gradual modification of the porosity of the mold region, thereby assisting in controlling the rate and extent by which a crust is formed onto the external surface of the mold region during polymerization. Formation of such a crust effectively forms a barrier to the existing vapors formed when the carrier liquid boils, thereby increasing the risk to uncontrolled cracking of such crust and/or formation of “popping” areas in the mold region, in which violent eruption of the vapors occurs. Controlling the extent and rate of polymerization by proper selection of the inorganic binder according to the temperature profile of the process, permits controlling the extent and rate of crust formation in the mold region to permit controlled evaporation of the vapors from within the paste during the temperature changes, while minimizing the risk of intra-layer mechanical damage due to pressurized vapors accumulation within the mold region.

According to some embodiments, the combination of refractory ceramic particles and inorganic binder is tailored such that the porosity of said mold region, when the binder is at the second polymerization state, is preferably kept smaller than a predefined threshold (e.g. for gray iron, about 60 m), such that the molten metal does not invade the mold region during molten metal casting. The inventors have shown that this limiting porosity can be sufficient to prevent metal breaching/leakage through the mold region thanks to the sufficiently high surface tension of the molten metal.

According to some preferred embodiments, the inorganic binder is a phosphate-based binder. The binder can be in liquid or solid form, e.g. particles.

It was surprisingly found by the inventors that unlike the common utilization of silicate-based inorganic binders, utilization of phosphate-based inorganic binders permit better control over the polymerization states when applying the paste composition in the additive metal casting process, while also providing significantly improved mechanical stability and self-adhesion properties in the applied casting process conditions. Further, it was found that in comparison to silicates, phosphate-based inorganic binders permit a broader range of working temperatures before final polymerization or thermal decomposition, thereby having a higher capability of withstanding the transient exposure to the molten metal temperatures during casting.

Moreover, it was surprisingly found that in the additive casting process conditions, phosphate-based inorganic binders tend to swell to a significantly lower degree compared to silicate-based binders; hence, the volumetric changes of the mold region in the paste compositions of this disclosure are significantly reduced when utilizing phosphate-based inorganic binders.

Phosphate-based inorganic binders undergo various sequences of chemical reactions during heating, such that different chemical and mechanical interactions between the binder molecules and between the binder molecules and the ceramic materials occur. The set of reactions occurring in each temperature defines the polymerization state of the phosphate-based inorganic binder. In other words, the chemical and/or crystalline phase which is obtained at a given temperature is considered a “polymerization state”, with polymerization states obtained at higher temperatures being defined herein as “higher polymerization states”. Similarly, polymerization states obtained at lower temperatures are defined herein as “lower polymerization states”.

In general, and without wishing to be bound by theory, phosphate-based inorganic binders undergo several chemical reactions to obtain different, temperature dependent, polymerization states. Bonding in a first step is initiated by a chemical reaction between the phosphates and the ceramic oxides in the presence of process-related water, e.g. an aqueous carrier liquid in the paste. The chemical reactions result in the formation of network-forming phosphates (e.g. aluminum phosphates, crystalline and amorphous), that lead to adhesive and cohesive bonding forces. This is referred to as the first polymerization state. At this stage, the cohesive and adhesive forces within the mold region are sufficient to provide the desired mechanical properties of the mold region for molten metal casting (and, if applied, to surface shaping of the mold region carried out before metal casting).

With increase of temperature, the phosphate binder transitions from hydrated phases to non-hydrated phases, accompanied by condensation and polymerization reactions of the phosphates, thereby increasing network formation. This is referred to as the second polymerization state. In this stage, the phosphate is still capable of adhering to “fresh” paste composition.

In general, the transition from the first polymerization state to the second polymerization state can be defined as the phase transition in which the inorganic binder transitions from its last hydrated phase to its first non-hydrated phase.

In a third reaction step at high-temperatures, reactions result in the formation of phosphates with higher crystallinity, mostly ortho phosphates, with simultaneous merging of the phosphate into the ceramics, to obtain final polymerization.

By some embodiments, the phosphate-based binder is selected from alkali metal trimetaphosphate (e.g. sodium trimetaphosphate, STMP), alkali metal monophosphate, aluminum phosphates, sodium tripolyphosphate, silico-aluminophosphate, monoaluminium phosphate, polyphosphates, dihydrogen aluminophosphate, polyphosphazene and mixtures thereof.

According to some embodiments, the phosphate-based binder is at least one aluminum phosphate.

Without wishing to be bound by theory, aluminum phosphates undergo several, temperature-dependent, reactions. For example, monoaluminium phosphate (AlH₃(PO₄)₂) gradually transformed into aluminum dihydrogen phosphate (Al(H₂PO₄)₃) via dehydration occurring during heating up to about 200° C. After that, further heating causes the formation of aluminum phosphate (AlPO₄), followed by type B aluminum metaphosphate (Al(PO₃)₃) and/or dimers thereof (Al₂P₆O₁₈) at about 500° C. Type B aluminum metaphosphate transforms to type A aluminum metaphosphate at heating to above 800° C., with final transformation into metaphosphate glass occurring at about 1200° C.

When the phosphate-based inorganic binder is an aluminum phosphate, the second polymerization state is obtained when the aluminum phosphate, e.g. MAP, is no longer hydrates. In other words, the first polymerization state is Al(H₂PO₄)₃, while in the second polymerization state the aluminum phosphate is in a crystalline phase which is one or more phases of AlPO₄, Al(PO₃)₃ and/or Al₂P₆O₁₈.

When the phosphate-based inorganic binder is MAP, the first polymerization state is characterized by at least partial transformation of MAP to Al(H₂PO₄)₃ (typically hexagonal phase). According to such embodiments, the second polymerization state is characterized by at least partial transition transformation of Al(H₂PO₄)₃ into a non-hydrated phase, typically into one or more of AlPO₄, Al(PO₃); and/or Al₂P₆O₁₈.

According to some embodiments, the concentration of said inorganic binder in the paste composition ranges between about 2 wt % and about 12 wt %, e.g. between about 2 wt % and about 11 wt %, between about 2 wt % and about 10 wt %, between about 2 wt % and about 9 wt %, or between about 2 wt % and about 8 wt %.

The term ceramic material means to denote a material or a composition which is neither metallic nor organic. A refractory ceramic material is a ceramic material that withstands high temperatures, typically over at least 600° C., without undergoing substantive chemical changes or thermal decomposition. The refractory ceramic material may be in particulate form, i.e. powder. The particles can be crystalline, semi-crystalline, amorphous, or any blend thereof.

According to some embodiments, the refractory ceramic material is selected from zirconia (ZrO₂), alumina (Al₂O₃), silica (SiO₂), zirconium silicate, yttria-stabilized zirconia, carbides (silicon carbide, tungsten carbide, etc.), nitrides (boron nitride, silicon nitride, etc.), and any mixture thereof.

By some embodiments, the refractory ceramic material is a mixture of zirconia (ZrO₂) and alumina (Al₂O₃).

According to some other embodiments, the refractory ceramic material is zirconia (ZrO₂).

According to some embodiments, the weight ratio between the refractory ceramic material and the inorganic binder in the paste composition is between about 1:1 and about 35:1, e.g. between about 2:1 to about 20:1, between about 2:1 to about 15:1, or even between about 2:1 to about 12:1.

In some embodiments, the paste composition is configured to be printable; namely, to be deposited from a bulk container through a suitable nozzle. Hence the paste composition should have a viscosity suitable for such dispensing. However, the paste composition also needs to substantially maintain its deposited (printed) shape until sufficient polymerization is obtained. Hence, careful balance and control over the paste's viscosity needs to be maintained.

According to some embodiments, the paste composition has a viscosity of at least about 10,000 cps (centipois, or mPa·s), e.g. between about 15,000 cps and about 50,000 cps.

According to some embodiments, one or more flow modifiers can be added to the paste composition to obtain the desired viscosity and/or rheological properties. For example, spherical particles, plasticizers, surfactants, thixotropic flow modifiers, non-Newtonic flow modifiers, temperature-dependent rheology modifiers, etc.

The paste composition may comprise one or more additional components, rendering the paste composition with one or more functional features or improved properties.

Depending on the carrier liquid and the properties of the refractory ceramic material and/or inorganic binder, surface active compounds or compositions can be used to maintain the refractory ceramic material and/or inorganic binder stable dispersed in the carrier liquid, at least for a pre-defined period of time (e.g. for pre-defined storage or during the additive casting process of a complete metal object). Thus, according to some embodiments, the paste composition further comprises at least one dispersant or surfactant. A surfactant (or a dispersant) is an agent that is capable of lowering the surface tension of a liquid, allowing for the formation of a homogeneous mixture of at least one type of liquid with at least one other type of liquid, or between at least one liquid and at least one solid. Exemplary suitable surfactants and/or dispersants are, inter alia, sodium dodecyl sulfate, cetyltrimethylammonium bromide (cTAB), or any other suitable surfactant.

According to some embodiments, the paste composition comprises between about 0.05 wt % and 5 wt % of at least one surfactant or dispersant.

Depending on the required rate of polymerization into the different polymerization states, the paste composition can, by some embodiments, comprise at least one polymerization modifier, e.g. a polymerization accelerant or a polymerization inhibitor. Examples for such polymerization modifiers include, inter alia, magnesium oxide, boric acid, sodium tetraborate, etc.

In some pastes, control over the mechanical properties or other properties of the paste composition can be obtained by addition of one or more co-binders. A co-binder is a material or a composition that co-acts with the main binder in the paste to modify one or more properties of the binder, such as polymerization rate, mechanical properties, etc. Exemplary co-binders are, inter alia, magnesium oxide (MgO), magnesium mono-phosphate (MgPO₄), polyvinyl pyrrolidone (PVP), polyvinyl alcohol (PVA), polyolefins, polypropylene carbonate, polydimethyl siloxanes (PDMS), and others.

According to some embodiments, the paste composition comprises at most about 15 wt % of said co-binder.

As noted, the paste composition and the mold region formed by deposition of the paste composition undergo substantive, and repeated cycles of thermal shocks due to the exposure to the high temperatures of the molten metal. Such thermal shocks can cause cracking and/or mechanical failure of the mold region. Thus, according to some embodiments, the paste composition further comprises at least one thermal shock resistive additive.

A thermal shock resistive additive is a material or composition having high thermal conductivity and low thermal expansion, rendering them suitable as additives to improve the resistance of the paste composition to thermal shocks. Some non-limiting examples of suitable thermal shock resistive additives are silicon carbide (SiC), graphite, graphene, carbon black, boron nitride, carbon nitride, silicon nitride, yttria-stabilized zirconia, etc.

In order to further increase the strength, i.e. directional strength, of the mold region, mechanical reinforcing agents can be added to the paste composition. The mechanical reinforcing agent can be in any suitable form, e.g. particles, flakes, discs, rods, short or long fibers, tubular particles, nanotubes, etc.

According to some embodiments, the paste composition can include one or more additional functional additives, such as releasing agents, polymerization activating/initiating agents (i.e. catalysts), UV absorbing agents, crosslinking agents, heat-absorbing agents, drying agents, etc.

In another aspect, the present disclosure provides a paste composition for manufacturing of a mold for additive casting of a metal object, the composition comprising:
between about 55 wt % and about 85 wt % of at least one refractory ceramic material in particulate form;
between about 2 wt % and about 30 wt % of at least one carrier liquid; and
between about 2 wt % and about 12 wt % of at least one inorganic binder having two or more, temperature dependent, polymerization states, a first of said polymerization states being obtained at a lower temperature than a second of said polymerization states.

By another aspect, the present disclosure provides a paste composition for manufacturing of a mold for additive casting of a metal object, the composition comprising:
between about 55 wt % and about 85 wt % of zirconia (ZrO₂) in particulate form;
between about 2 wt % and about 30 wt % of at least one carrier liquid; and
between about 2 wt % and about 12 wt % of at least one aluminum phosphate.

According to another aspect of this disclosure, there is provided a method of preparing a paste composition as disclosed herein, the method comprising mixing said at least one refractory ceramic material with a mixture that comprises said carrier liquid and said at least one inorganic binder, to obtain said paste composition.

According to another aspect of this disclosure, there is provided a method of preparing a paste composition as disclosed herein, the method comprising providing a mixture that comprises said carrier liquid and said at least one inorganic binder, and mixing said at least one refractory ceramic material and said second mixture to obtain said paste composition.

By some embodiments, the refractory ceramic material can be added to the mixture of the binder and carrier liquid step-wise. Alternatively, by some other embodiments, the mixture can be to the refractory ceramic material step-wise.

According to some embodiments, the entire mixture is added to the refractory ceramic material. Alternatively, the entire content of refractory ceramic material is added to the mixture.

According to some embodiments, mixing is carried out at a temperature of no more than about 30° C., e.g. the temperature is maintained during mixing at a range of between about 10° C. and about 25° C.

According to some embodiments, one or more pre-treatments can be applied to the refractory ceramic material. Thus, any one of the following pre-treatments can be applied to the refractory ceramic material prior to mixing with the components of the paste composition: modifying the moisture content of the ceramic particles (e.g. drying or hydrating the ceramic particles), modifying the particles' morphology (e.g. rounding, forming jagged shape, etc.), modifying the size of the particles (e.g. milling, sieving, crushing, agglomerating, fracturing, etc.), modifying the surface texture of the particles (e.g. smoothing or roughening), modifying the surface properties or composition of the particles (e.g. coating, absorbing binding moieties, activating), or any other suitable pre-treatment.

By another aspect, there is provided a method of preparing a paste composition as disclosed herein, the method comprising coating said at least one refractory ceramic material with at least a portion of the content of said inorganic binder to obtain coated ceramic particles, and mixing said coated ceramic particles with said carrier liquid to obtain said paste composition.

By some embodiments, the carrier liquid further comprises a complementary portion of the inorganic binder.

In other words, in such a method the total content of the inorganic binder paste composition is divided into two portions, one portion coating the particles of the refractory ceramic material, and a complementary portion formulated into the carrier liquid to be mixed with or applied onto the coated ceramic particles, for forming together the paste composition.

By another aspect, this disclosure provides a cartridge for holding and dispensing the paste composition as disclosed herein, the cartridge comprises a container for holding the paste composition, one or more dispensing nozzles configured to permit dispensing of the paste composition from the container, and one or more mixing means disposed within the container for mixing the paste composition.

The cartridge is typically designed for interfacing with a suitable deposition system, such as that described in PCT patent applications publication numbers WO2019053712, WO2023002468 and WO2022243921, and/or in PCT patent applications serial numbers, PCT/IL2022/051188, PCT/IL2022/051190, and PCT/IL2022/051191, all of which assigned to the assignee of the present application, and incorporated herein by reference.

The cartridge can be designed to be detachably attached to said deposition system. Alternatively, the cartridge can be designed to be an integral part of the deposition system, and configured for filling with said paste composition upon demand.

As the paste composition is a viscous slurry, the cartridge comprises one or more mixing means to maintain homogeneity of the paste composition before and during deposition. The term mixing means is meant to denote any suitable mixing or agitation means that can keep the paste composition under flow to minimize or avoid sedimentation of the refractory ceramic material and/or inorganic binder out of the slurry. Exemplary mixing means are mechanical stirrers, magnetic stirrers, ultrasonic transducers, circulation loops, etc. The container can also include one or more baffling arrangements or flow diverters to obtain a pre-defined flow profile within the container.

According to some embodiments, the mixing means are configured for continuous or intermittent mixing of the paste in the container.

It is at time desired to introduce one or more gasses, e.g. inert or reactive gases, into the container. For example, depending on the stability or volatility of additives in the paste composition, it is desired to maintain the paste under inert conditions or under slightly pressurized conditions. Thus, according to some embodiments, the cartridge can comprise one or more gas inlets, configured for introducing gas into the container.

According to some embodiments, the container is configured to maintain the paste composition under pressure.

The cartridge can also include one or more vents to permit gas discharge from the container, for example of gaseous reaction products or liquid carrier products.

In a further aspect, there is provided a process for additive printing of a metal object, the process comprising:
depositing a paste composition as disclosed herein onto a receiving surface to form at least one first mold region;
heating the at least one mold region to a first temperature to polymerize said inorganic binder to said first polymerization state;
depositing molten metal into a cavity defined by the at least one first mold region, to obtain at least one metal object region, said binder being heated by the molten metal to said second polymerization state;
allowing the metal to at least partially solidify, thereby obtaining a first production layer; and
depositing paste composition onto said first production layer to form at least one subsequent second mold region, the second polymerization state in the first mold region being sufficient to permit adhesion of the second mold region to said first mold region.

As used herein, the singular form “a”, “an” and “the” include plural references unless the context clearly dictates otherwise.

As used herein, the term about is meant to encompass deviation of +10% from the specifically mentioned value of a parameter, such as temperature, pressure, concentration, etc.

Whenever a numerical range is indicated herein, it is meant to include any cited numeral (fractional or integral) within the indicated range. The phrases “ranging ranges between” a first indicate number and a second indicate number and “ranging ranges from” a first indicate number “to” a second indicate number are used herein interchangeably and are meant to include the first and second indicated numbers and all the fractional and integral numerals therebetween.

Unless the context requires otherwise, the word comprise, and variations such as comprises and comprising, will be understood to imply the inclusion of a stated integer or step or group of integers or steps but not the exclusion of any integer or step or group of integers and steps.

Generally, it is noted that the term . . . at least one . . . as applied to any component of a composition of this disclosure should be read to encompass one, two, three, four, five, or even more different occurrences of said component in the composition.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1B are schematic representation of an additive casting process of a metal object, in which paste compositions of this disclosure are used for construction of the mold regions in the production layers of the mold-metal fabricated structure.

FIG. 1C is a schematic top view of a production layer comprising a mold region and a metal object region.

FIG. 2 is a schematic representation of the temperature profiles in the mold structure during the additive casting process of FIG. 1.

FIGS. 3A-3B are pictures showing various mechanical artifacts in mold configurations prepared in a process carried out with a silicate-based binding system.

FIGS. 4A-4B are pictures showing various mold configurations prepared in a process carried out with a paste composition of this disclosure with phosphate-based binding system.

FIG. 5 shows a mold-metal structure, produced by additive casting process with the Test composition.

FIGS. 6A-6B are 3-point bending test results for the Reference and Test compositions: failure stress (FIG. 6A) and failure strain (FIG. 6B).

FIGS. 7A-7B are adhesion test results for the Reference and Test compositions: failure stress (FIG. 7A) and failure strain (FIG. 7B).

FIG. 8A is a general art stress-strain curve, schematically exemplifying the theoretical mechanical behavior of ceramics, metals and plastics.

FIG. 8B is a general art representative stress-strain curve of a brittle material under tensile and compressive stresses.

### DETAILED DESCRIPTION OF EMBODIMENTS

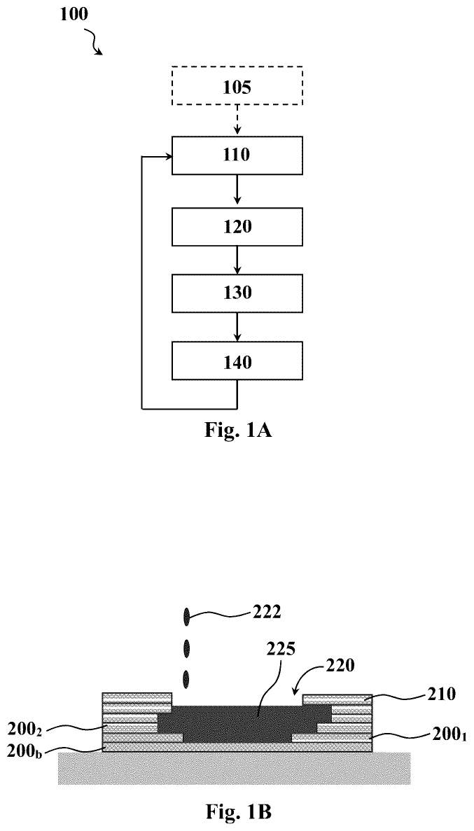

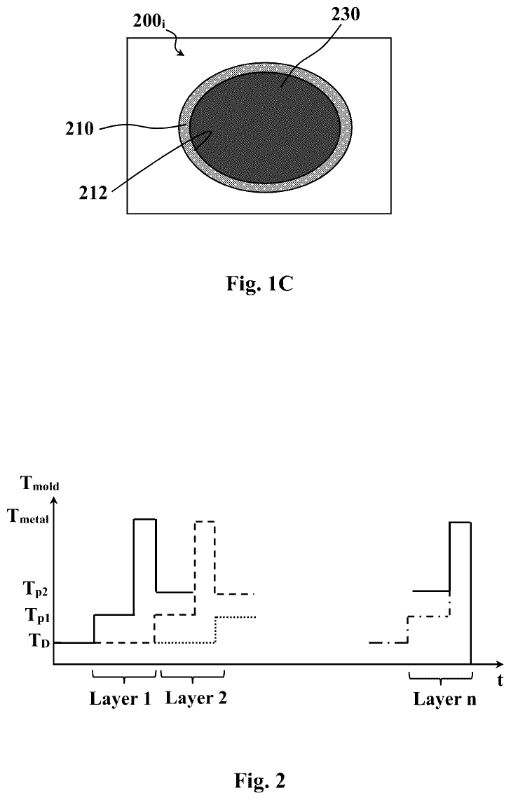

Reference is first being made to FIGS. 1A-IC and FIG. 2 showing the steps of an exemplary additive casting process of a metal object, in which paste compositions of this disclosure are used for the construction of a mold-metal structure fabricated from a stack of production layers.

Process 100 comprises deposition 110 of a paste composition according to a desired mold contour in a production layer 200i (i being an integer (i>0) defining the number of the production layer). Deposition of the paste is typically carried out at a defined deposition temperature (T_{D}), which is the temperature at which the paste is typically maintained within a deposition cartridge or container, e.g. ambient temperature. The deposited paste composition is then heated at step 120 to a first temperature (Tₚ₁), continuously or in several heating intervals, which is the temperature in which the first polymerization state of the inorganic binder in the paste is obtained, to form the mold region 210 of the production layer 200₁.

At this stage, the mold region 210 is stable enough to carry out one or more post-deposition surface treatments (not shown), if desired, in order to smoothen the surface texture (e.g. the inner walls 212 of mold region 210) or define surface features of the mold region.

At step 130, molten metal is being cast into the cavity 220 defined by the mold region. During step 130, the inorganic polymer undergoes transition to the second polymerization state (Tₚ₂). The metal 225 then cools at step 140 to a temperature corresponding to T_{P2}, thereby forming the object region 230 and completing the manufacture of the first production layer, before deposition of fresh paste to form the mold region of the ensuing production layer 2002. The cycle of steps 110-140 is repeated, such that a stack of production layers is obtained, by consecutive cycles of production layers fabrication, until the end of the casting of the entire metal object.

Step 130 comprises the deposition of molten metal (represented in FIG. 1B by molten metal drops 222) into cavity 220. For example, molten metal 222 is deposited while a metal depositor (not shown) is positioned above cavity 220. Step 130 may comprise pre-deposition heating of the previously-cast object region(s) 225 such that the top surface of object region 225—the previously deposited metal—may be in at least partially molten state during molten metal deposition of the subsequent quanta of molten metal. Step 130 may further comprise post-deposition heating of the deposited object region to modify its cooling profile. In some embodiments, step 130 is implemented in a sequential manner on a plurality of working areas (not shown) that constitutes object region 220. For example, a metal head (not shown) composed of molten metal depositor and working area heater, travels over object region 220 during step 130.

As seen in FIG. 1A and FIG. 2, prior to deposition of the first mold region, a base paste layer 200b can be deposited (at step 105), as a substantially continuous base layer (i.e. without object regions), thereby functioning as a solid mold base layer. To ensure mechanical stability and proper adhesion to the first mold region of first production layer 200₁, the base layer 200b typically undergoes gradual heating to said second temperature prior to deposition of the first mold region.

As noted, the paste compositions of this disclosure are designed to be suitable for such mold-metal additive casting processes, particularly tailored to maintain their mechanical stability and mold integrity during the cycles of extensive heat shocks and applied stresses (e.g. due to volume changes of the melting and solidifying metal in the object region). The paste compositions utilize inorganic binders that have several, temperature dependent, states of polymerization, such that the mechanical properties of the mold region (and of the overall mold obtained by the stacked mold regions) and the inter-layer adhesion between the stacked mold regions minimize the risk of mold cracking, intra- and inter-layer metal infiltration, and/or molten metal leakage out of the mold.

In other words, the paste composition is designed to form a refractory ceramic-based mold region, in which an inorganic binder that has different polymerization states at different temperatures is used. Depending on the temperature to which the binder is exposed to during the production of the production layer, the binder undergoes a change in polymerization states, thereby modifying the mechanical properties of the mold region to suit the specific production stage.

As noted above, the paste compositions of this disclosure are designed to permit deposition of relatively thick or voluminous mold regions, thereby providing sufficient mechanical support to relatively large amounts of molten metal cast in each casting cycle. Due to large volume of paste composition forming the mold region, and therefore the time required for thermal energy to be transported throughout the mold region, the transition of the inorganic binder from the first polymerization state to the second polymerization state occurs first at the surface of the mold region, advancing inwards into the volume of the mold region. Hence, until temperature equilibration throughout the volume of the mold region, the inorganic binder can be at different polymerization states within the volume of the mold region. For ease of reference, T_{mold} in FIG. 2 refers to the temperature of the mold region at its surface.

The inventors of the presently disclosed technology have come to the surprising understanding that a group of inorganic binders having several, temperature-dependent, polymerization states, can be effectively utilized in the sequential formation of mold regions in consecutively fabricated production layers in additive casting of metal objects. It was surprisingly found that by proper selection of the inorganic binder, different stages of polymerization of the paste composition can be obtained and tailored to temperatures of the additive casting process, thereby enabling casting the molten metal when the mold region is at an appropriate green body state. As the pastes of the present disclosure enable obtaining satisfactory mechanical properties and mold integrity without requiring sintering prior to metal casting, not only an improved mold is obtained, but also significant reduction in overall process time and energy consumption.

As described above, the configuration of the mold regions, as well as relative positions of the mold regions of adjacent production layers, are defined by the configuration of the metal object to be manufactured concurrently with the mold structure. For simplicity of illustration, the configuration of the mold region in FIG. 1C shows a simplified design, e.g. ring cross sections. In FIG. 1C, the metal-facing side (inner wall 212) of the mold region 210 faces metal residing in the same production layer (the ‘mold over mold’ production scenario). However, as is evident from FIG. 1B, in some production scenarios, the metal-facing side of a mold region may face metal residing in the next produced production layer (the ‘metal over mold’ production scenario); in other production scenarios, the metal-facing side of a mold region may face metal residing in the previous production layer (the ‘mold over metal production scenario).

Advantages of phosphate-based inorganic binders will now be demonstrated, when used in a paste composition for sequential mold forming in the additive casting process. However, before turning to the examples, a brief general explanation of mechanical behavior of ceramics is provided, in order to provide the reader with relevant background.

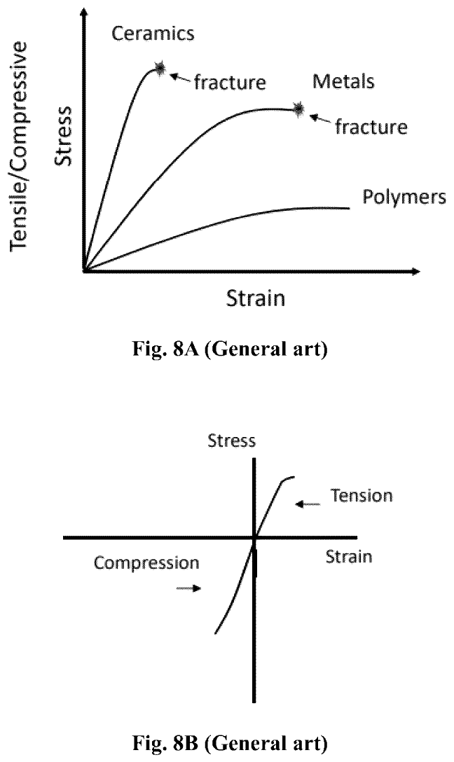

Stress-strain curves are typical representations of a given material deformation in response to various mechanical loads, such as axial loads, e.g. tensile or compressional, or angular load such as torsional loads. As can be seen in FIG. 8A, the stress-strain curve for a typical ceramic material is almost a straight line up to a yield point, both under tensile or compressive stresses, soon after which the ceramic suddenly reaches the fracture point and breaks. Metals are ductile materials, exhibiting plastic deformation before fracture (during the flattened part of the curve), whereas ceramics exhibit negligible plastic deformation under external loading (hardly any flattened part in the stress-strain curve in FIG. 8A). This property of ceramic materials justifies their definition as brittle (opposite of ductile) materials. FIG. 8B shows a representative (qualitative) stress-strain curve of a brittle material under tensile and compressive stresses where opposite signs of the strains under tensile/compressive stresses are clearly indicated.

Though being brittle materials, ceramics have compressive strengths about ten times higher than their tensile strength (strength is defined as the maximum stress in the relevant tension/compression quadrants of the stress-strain diagram). The discrepancy between tensile and compressive strengths is in part due to the brittle nature of ceramics. When subjected to a tensile load, ceramics, unlike metals, are unable to yield and relieve the stress. The tensile strength of ceramics is low because existing flaws (internal or surface cracks) act as stress concentrators, resulting in a tendency of a material to fracture/crack with very little or no detectable plastic deformation beforehand. However, for example, under a compressive load, a transverse crack in a ceramic material may tend to close up and so cannot propagate, unlike fast crack propagation obtained under tensile loads.

The ability of a material to deform under compression (plastically or elastically) is termed compressibility. The ability of a material to absorb energy in the process before fracture is termed toughness. It should be noted that ductility is a measure of how much something deforms plastically before fracture. However, just because a material is ductile does not make it tough. The key to toughness is a good combination of strength (tensile/compressive) and ability to deform (under compression and/or tension). A material with high strength (tensile/compressive) and high ductility has higher toughness than a material with low strength and high ductility.

Young's modulus (or modulus of elasticity) measures a material's rigidity. The more rigid the material, the higher its modulus of elasticity. A material is considered to exhibit brittle fracture if its behavior is elastic virtually up to failure. Young's modulus does not depend on faults (microcracks) in the material. Toughness, on the other hand, is a measure of a material's resistance to crack propagation. Unlike mechanical strength, toughness is independent of fracture-initiating flaws (microcracks), though it depends on the microstructure of the material.

In order to be tough, a material must be both strong and ductile. Therefore, one way to measure toughness is by calculating the area under the stress-strain curve from a tensile test. This value (the area under the stress strain curve) is simply called “material toughness” and it has units of energy per volume. Material toughness equates to a slow absorption of energy by the material. Toughness tends to be small for brittle materials, because elastic and plastic deformations allow materials to absorb large amounts of energy. Thus, brittle materials, when subjected to stress, break with little elastic deformation and without significant plastic deformation. Brittle materials absorb relatively little energy prior to fracture, even those of high strength.

### Example 1

A paste composition based on zirconia powder was prepared with two inorganic binding systems: a typical silicate based binding system utilized in preparation of standard refractory cast-molds, and a phosphate-based binding system. The tested compositions are shown in Table 1:

TABLE 1
silicate-based composition (Reference)
vs. phosphate-based composition (Test)

| | | Reference | Test composition |
|---|---|---|---|
| Component | Function | (wt %) | (wt %) |
| Zirconia powder | Refractory ceramic | 65-80 | 65-80 |
| Sodium silicate | Silicate binder | 3-5 | — |
| Aluminum | Phosphate binder | — | 3-6 |
| phosphate | | | |
| Additives | Surfactants, | 1-7 | 1-7 |
| | solvents, etc. | | |
| Water | Carrier liquid | 9-30 | 8-30 |

The compositions were utilized in the same additive casting process as mold regions in sequential fabrication of production layers, under the same process conditions (e.g. same temperatures and time intervals) in metal casting of gray iron. The processes were carried out in atmospheric environment, under the same casting sequence.

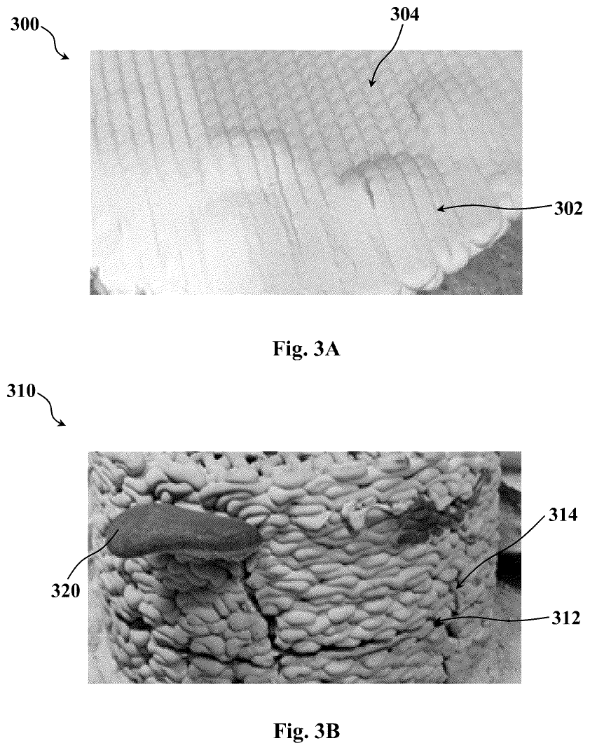

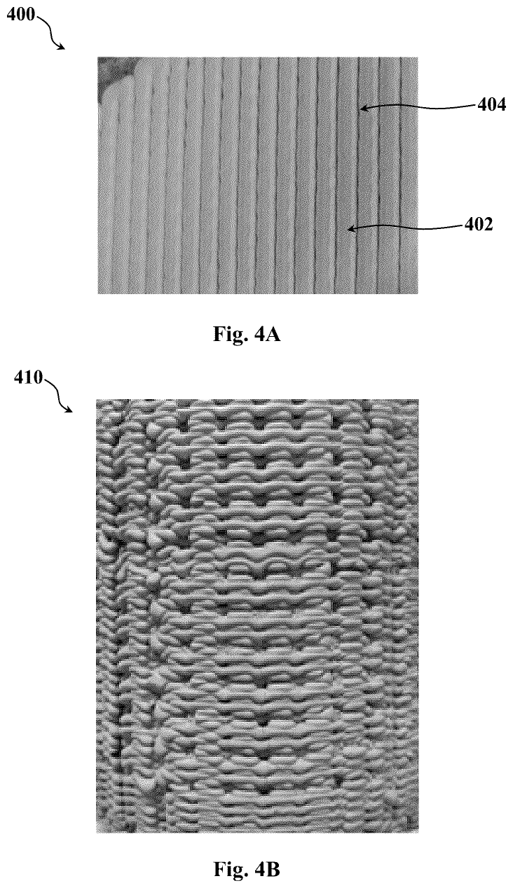

Reference is now made to FIGS. 3A-3B showing various mold configurations prepared in a process carried out with the Reference composition (silicate-based binding system), together with FIGS. 4A-4B that show molds prepared in the same process with the Test composition that was based on a phosphate binding system.

FIG. 3A and FIG. 4A show the results of a first experiment of raft printing, aimed for assessing mold material integrity. The mold material-silicate based material in FIG. 3A and phosphate-based material in FIG. 4B-were printed on a hot build plate.

FIG. 3A shows a raft 300 made of silicate-based material. The silicate based mold material exhibits swellings 302. The swells may rise up to 5 mm in height. When the silicate-based material was exposed to molten metal, the swelled portions may expand and rupture, turning into voids. In case the surface of the silicate-based material is treated (e.g. by milling, polishing or grinding), the top of the swelled portions is removed, leaving an undesired crater. Consequently, the molten metal that is deposited into the mold region will undesirably fill the crater, causing a deformity in the metal object. Further, the swelling creates unleveled surface that, in turn, undesirably results in non-homogeneous metal deposition.

FIG. 4A shows a raft 400 made of the Test composition, and printed in the same manner over the same build plate at the same temperature. No swells were observed as seen, for example, in the flat top surface 402.

FIG. 3A further shows unleveled top surface 304 caused by print-height fluctuations of the extruder during printing of the Reference composition. The same extruder, demonstrating the same print-height fluctuations, was used for printing the Test composition. FIG. 4A shows smooth upper surface 404, indicating improved leveling of the phosphate-based material in comparison to the silicate based material.

FIG. 3B shows a mold-metal structure 310 made of a silicate-based material of several stacked mold regions (a 7-layers stack is shown), filled with metal mold 310 exhibited inter-layer cracks 312 (i.e. horizontal cracks), cross-layer cracks 314 (i.e. vertical cracks), and metal breakthrough 320 (metal breach). Horizontal cracks 312 were caused due to faulty adhesion between stacked mold regions, as it was observed that the silicate-based binders undergo full polymerization at a temperature lower than the temperatures that develop at the metal-mold interface when casting the molten metal Hence, in the silicate-based binding system, the surface of the mold region is rendered “inactive” (i.e. fully polymerized), hindering the ability of a subsequent deposited mold region in the stack to sufficiently adhere to the previously deposited mold region.

Vertical cracks 314 were caused in response to mechanical forces acting on the mold due to metal expansion cycles, namely due to the repeated mechanical shock exerted onto the mold when the metal changes its volume during temperature changes in the additive manufacturing process.

Metal breach 320 indicates a mechanical failure of the mold at the vertical cracks and/or horizontal cracks, such that the molten metal breached the mold structure.

Such breaches result in further post-production processing, as the excessive metal cannot be removed during manufacturing. Further, the volume of metal that leaked through the mold caused partial depletion of molten metal at the corresponding object region. Further still, such mold failures may hinder or even prevent proper deposition of subsequent mold regions on top of the mold region that experienced metal breach. In many cases, after the metal breaches the mold, the manufacturing process must be stopped.

FIG. 4B shows a mold-metal structure 410 made of a phosphate-based composition, constructed of several stacked mold regions. The stack included 13 mold regions, vertically stacked one over the other, each region being between 4 and 8 mm thick, filled with metal (the metal was deposited within the mold and cannot be seen). As can be seen, structure 410 exhibited no horizontal cracks, vertical cracks and/or any metal breaches.

The behavior illustrated in FIGS. 3A-3B indicates that the silicate binding system does not provide for sufficient chemical and mechanical properties to withstand the thermal and mechanical cycles exerted on the mold structure during the additive manufacturing process. In other words, the silicate binding system does not exhibit the required, temperature-dependent, transitions between polymerization states at the temperatures required for the additive manufacturing process.

In comparison to silicate based material, the phosphate-based material was shown to significantly reduce the horizontal and vertical cracks. Thus, the phosphate-based binder was found to demonstrate transitions between several polymerization states at a wide range of process temperatures, such that at least portions of the deposited mold region surface are at the proper polymerization state (i.e. at the second polymerization state) to permit sufficient adhesion to the paste composition deposited thereonto in the next cycle of production layer manufacturing.

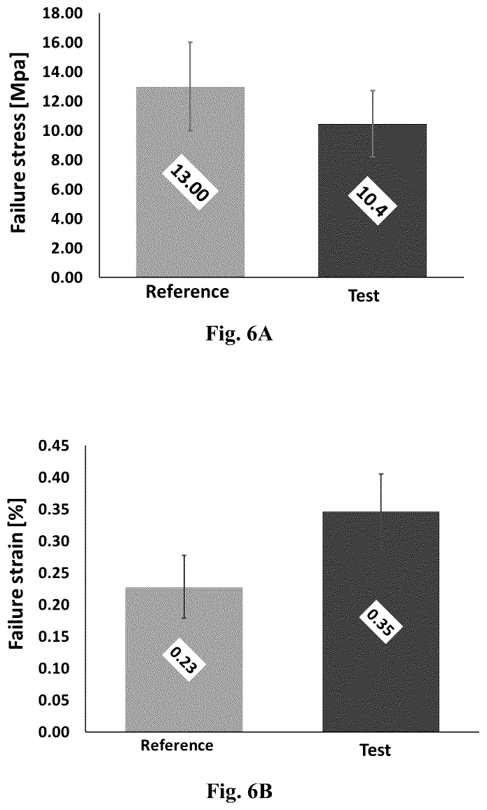

Thus, it is evident that paste compositions of the present disclosure are significantly superior to standard silicate-based compositions typically used in the field of metal casting, as will also be discussed with respect to FIGS. 6A-6B further below.

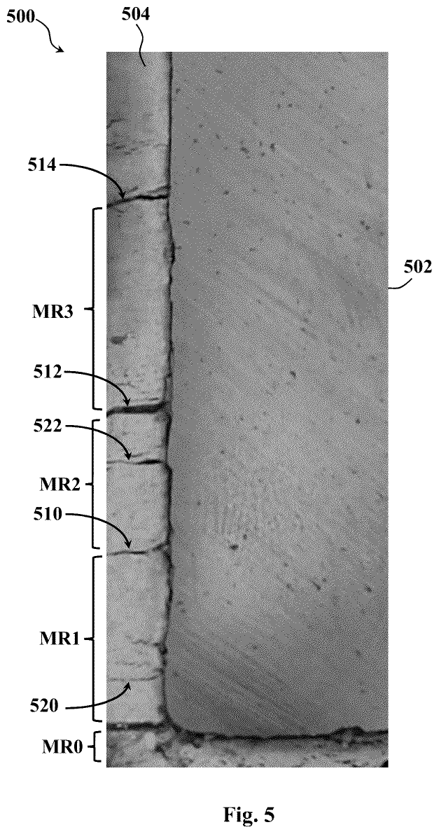

FIG. 5 shows an enlarged sectional view of a mold-metal structure 500 manufactured in the additive manufacturing process described herein using gray iron (portion 502 of the metal object) and the Test composition (mold portion 504). The picture shown in FIG. 5 was taken after the completion of manufacturing of the mold-metal structure, and before the mold structure was removed. The complete mold-metal structure was cut along its longitudinal direction.

The shown section 500 includes several stacked mold-metal production layers, respectively indicated as MR1, MR2, and MR3. The interfaces 510, 512 and 514 between mold regions MR1, MR2, MR3 and MR4 can be seen.

The sequence of manufacturing of mold-metal structure 500 was as follows: a base mold layer MR0 was first deposited. Then, 4 mold sub-layers (print lines) were deposited (i.e. printed) one on top of the other, constituting together mold region MR1. Then, the inner wall of mold region MR1 was smoothened and cleaned. Molten metal was then deposited into the cavity delineated by mold region MR1.

After cooldown, the first mold sub-layer (print line) of mold region MR2 was deposited on top of the upper surface of mold region MR1, to thereby form interface 510; the rest of the mold sub-layers of mold region MR2 were then printed. The inner wall of mold region MR2 was smoothened and cleaned. Then, after heating the metal previously deposited into mold region MR1, molten metal was deposited into the cavity delineated by mold region MR2, followed by additional heating to the deposited metal.

The same operations were performed with respect to mold region MR3 and subsequent mold regions, until the fabrication of the complete mold-metal structure (not shown) was complete.

The Test composition was used to construct mold regions, including mold regions MR0-MR3 that can be seen in FIG. 5. MR1 was constructed by applying 4 mold layers (print lines) each of about 2 mm height. MR2 was constructed by applying 3 mold layers (print lines) each of about 2 mm height. MR3 was constructed by applying 5 mold layers (print lines) each of about 2 mm height. The metal-facing surfaces of mold layers of the same mold region—i.e. the inner wall of the respective mold region—were treated with a surface milling unit prior to molten metal deposition. This is evident from FIG. 5, as no mold sagging are observable.

The conformity of the outer side of the metal object 502 with the inner wall of the mold structure 504 can clearly be seen. No vertical cracks and horizontal cracks yielding any metal breakthrough can be observed. No metal penetrated or leaked through interfaces 510, 512 and 514 and the integrity of the mold structure 502 was maintained during the fabrication of the complete mold-metal structure. This attests to the suitability of the Test composition to the additive manufacturing process, demonstrating improved inter-layer adhesion and improved mechanical stability to repeated thermal and mechanical shock cycles.

Only minor mold sub-layer (print line) interfaces 520 and 522 between print lines of the same mold region (MR1 and MR2, respectively) can be seen. No further visible interfaces between sub-layers within the same mold region were observable for MR1-MR3. Hence, complete adhesion and material continuity was substantially obtained between sub-layers within each mold region. No metal penetrated or leaked through mold sub-layer interfaces 520 and 522.

The integrity of the mold structure 502 in the area of mold layer (print line) interfaces 520 and 522 is maintained during the fabrication of the complete mold-metal structure—including during the milling operations exercised on the inner walls of the respective mold region.

### Examples 2 and 3

The cohesion properties (the inner strength of the mold structure) and the adhesion properties (bonding quality) of the Reference and Test compositions of Table 1 were 3-point bending tests. Several specimens of the material being tested (beam samples) were prepared with the same dimensions and geometry. The Reference and Test beam samples were tested using the same equipment and test set-ups.

The specimen were prepared in a sequential manner, mimicking the production flow to some extent: the first beam sample of the specimen—a section of a mold layer suitable for additive metal casting (e.g. of about 3-5 mm thick and 10 cm length) was deposited on a build plate that was then placed in an oven at 250-300° C. for a few minutes. After the build plate was taken out of the oven, the second beam sample was printed on top of the first beam sample. The build plate was then returned to the oven for a few minutes, and so on, until a structure of several beam samples was received. The final sample included a mold structure section of at least 10 cm in length, about 2-3 cm width and 3-5 mm thick. The final samples did not undergo mechanical surface treatment and remained with rough and uneven surfaces. The final sample was not exposed to typical melting temperatures of metal, e.g. gray iron (1200° C.).

The cohesion test was performed by applying force perpendicular to the length dimension in the middle of the sample. The adhesion test was performed by applying force parallel to the length dimension in the middle of the sample.

The cohesion test results are provided in FIGS. 6A-6B, which show a comparison of the failure stress and failure strain of the compositions. The failure stress results in MPa represent the maximum stress that the specimen can withstand before failure occurs. The failure strain results in % represents the deformation of the length of specimen in response to stress.

The failure stress value of the Reference composition-13 MPa, is 20% higher compared to the failure stress value of the Test composition-10.4 MPa. Nevertheless, the failure stress value of the Test composition is suitable for additive metal casting (for example, as discussed with reference to FIGS. 4A-4B). More importantly, the failure strain value of the Test reference-0.35%, is about 50% higher than the failure strain value of the Reference-0.23%.

As evident, the Test composition demonstrated higher failure strain and lower failure stress compared to the Reference composition, indicating that the Test composition has higher toughness (i.e. strength and flexibility/ductility) compared to the Reference composition, which is more brittle and of lower toughness. In other words, the Test composition provides higher tolerability to application of mechanical stresses, providing improved flexibility to withstand repeated mechanical loadings to which the mold is exposed in the additive casting of the molten metal.

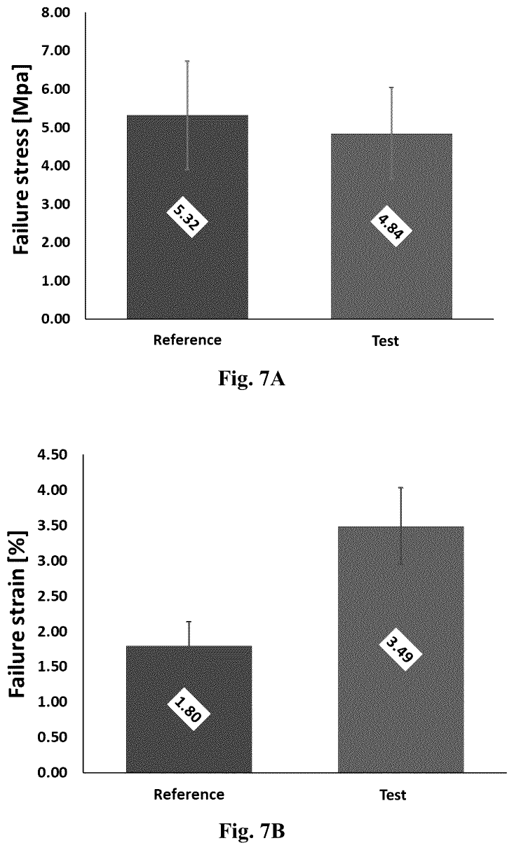

The adhesion test results are provided in FIGS. 7A-7B, which show a comparison of the failure stress and failure strain of the compositions. The failure stress value of the Reference composition-5.32 MPa, is about 10% higher compared to the failure stress value of the Test composition-4.84 MPa. The failure strain value of the Test reference-3.49%, is 94% higher than the failure strain value of the Reference-1.8%. As evident, the Test composition demonstrated higher failure strain and lower failure stress compared to the Reference composition, indicating that significantly better adhesion was obtained for the Test composition compared to the Reference composition.

The cohesion and adhesion test results of the additional specimen prepared in a process involving the oven temperatures of 500° C. and 800° C. (not shown) demonstrated resulted in similar mechanical behavior to those shown in FIGS. 6A-7B, i.e. similar significant differences were observed between the mechanical behaviors of the Reference and Test compositions' samples.

In view of the experimental results, significant differences were observed between the silicate-based Reference composition and the phosphate-based Test composition. Without wishing to be bound by theory, these differences are primarily attributed to the differences in temperature-dependent behaviors of the compositions. While the silicate-based composition demonstrated complete polymerization and increase in crystallization at low temperatures (200-300° C.), in the Test composition the phosphate-based binder is polymerized to a polymerization state (the second polymerization state) that still maintains the surface of the deposited composition “active”. Thus, in the temperatures of the additive metal casting process, the Test composition is at a polymerization state that renders it sufficiently active to ensure proper adhesion to additional Test composition applied thereto (i.e. the subsequently applied mold region). Hence, the Test composition was found to be particularly suitable for use in additive metal casting, which involves multiple iterations of molten metal deposition, as well as multiple rounds of heating portions of the solidified metal bulk prior to depositing the next metal layer. Unlike silicate-based binders utilized in the Reference composition, the phosphate-based binders were found to provide superior adhesion and cohesion properties.

During the additive casting process, previously deposited metal (i.e. in a lower production layer) undergoes significant volume change expansion, thereby exerting pressure on the mold region from the metal-mold interface, in addition to the pressure exerted by a portion of the molten metal during casting of the successive production layer. Therefore, circumferential tensile stresses develop inside the mold region all along the mold perimeter. In addition, additional axial stresses (tensile and compressive) develop due to the self-weight of stacked mold regions, and potential dimensional changes of previous mold regions due to the cycled thermal and mechanical loads experienced during the casting process.

Further to the complete polymerization at circa. 200-300° C., silicate binders undergo at least partial sintering at temperatures higher than 700° C. Hence, under the process conditions, when metal is cast into the production layer, a silicate binder will be highly brittle, with relatively low toughness. Further, silicate-binders, as demonstrated in Example 1 above, were found to create intra- and inter-layer voids, functioning as stress concentrating regions, promoting early mechanical failure. This is also evident from the high failure strength and relatively low failure strain of the Reference composition, which indicates a stiff material, that does not accommodate cycled volume changes.

Unlike the silicate-based binders, the Test composition based on a phosphate binding system, permits working with the mold region well below sintering conditions, i.e. as a green body with high tolerability to significantly higher process temperatures, thereby enabling to obtain high toughness, i.e. optimal combination of strength and flexibility/ductility. In compositions of the present disclosure, a balance is obtained between high temperature behavior (i.e. the various polymerization states of the binder), and high toughness, which provides not only high strength but also accommodation for sufficient amount of strain to minimize cracking during cycled application of mechanical stresses.

As evident by the Examples, and supported by proper adhesion between the mold regions of ensuing production layers is of outmost importance to ensure mold integrity during the repeated thermal shocks and mechanical stresses developing during the additive casting process. The inorganic binder in the paste composition is selected such that once a production layer is fabricated, at least portions of the mold region remain at a proper polymerization state to provide sufficient adhesion of the ensuing mold region deposited thereonto, such that inter-layer cracks or inter-layer mechanical failure is minimized (at time eliminated).

As also evident from the Examples, as silicate binders undergo at least partial sintering and/or alternatively substantive glassy-crust formation in the mold regions at the temperatures of the additive casting processes, silicate binders were found to provide inferior inter-layer adhesion. Unlike silicates, in the Test composition, the phosphate-based binding system is selected as to maintain an “active” binder due to the gradual polymerization into different, temperature-dependent polymerization states, in which after metal deposition, the binder is still in a suitable polymerization state (at least in the immediate production layer), thereby providing sufficient adhesion capability to freshly deposited mold region of that is applied thereonto to form the next production layer.

Another difference that may result from such crust formation is the ability to release vapors developing in the mold region during drying. During various stages of heating, the carrier liquid boils, resulting in vapors that need to be released from the paste after its deposition as a mold region. Gradual polymerization of the binder allows for gradual modification of the porosity of the mold region, thereby assisting in controlling the rate and extent by which a crust is formed onto the external surface of the mold region during polymerization. Formation of such a crust effectively forms a barrier to the existing vapors formed when the carrier liquid boils, thereby increasing the risk to uncontrolled cracking of such crust and/or formation of “popping” areas in the mold region, in which violent eruption of the vapors occurs. Controlling the extent and rate of polymerization by proper selection of the inorganic binder according to the temperature profile of the process, permits controlling the extent and rate of crust formation in the mold region to permit controlled evaporation of the vapors from within the paste during the temperature changes, together with controlled porosity modifications to ensure proper vapor transport out of the mold region.

It should be noted that the present disclosure is not limited to the production conditions and operational parameters provided in the above-discussed Examples, and the present disclosure may be implemented in various production conditions and operational parameters. The present disclosure is not limited to the casting of gray iron objects and various metals and/or metallic alloys which are suitable for melting and casting, can be used, for example, other iron types, steel and other ferrous alloys, aluminum alloys, copper alloys, nickel alloys, magnesium alloys, and the like.

Aspects of the present disclosure were illustrated with reference to the deposition of the mold material in the form of a solid paste tube with circular cross-section. The present disclosure is not limited by the cross-section of the mold paste as well as by the cross-section shape and dimension of the mold paste.

1. A paste composition for manufacturing of a mold for additive casting of a metal object, in a process of subsequent formation of production layers, each production layer comprising at least one mold region and at least one metal object region, each production layer being manufactured by deposition of said paste composition to form said mold region, drying said mold region, and deposition of molten metal into a cavity defined by the mold region to obtain the metal object region, the paste composition comprising:
between about 55 wt % and about 85 wt % of at least one refractory ceramic material in particulate form;
between about 8 wt % and about 30 wt % of at least one carrier liquid; and
between about 2 wt % and about 12 wt % of at least one phosphate-based inorganic binder having two or more, temperature dependent, polymerization states, a first of said polymerization states being obtained at a lower temperature than a second of said polymerization states,
wherein the particles of the refractory ceramic material and the inorganic binder are dispersed in the carrier liquid thereby providing a paste consistency,
the inorganic binder being selected to undergo polymerization to said first polymerization state during deposition and/or drying of the mold region at a first temperature ranging between about 80° C. and about 200° C., and to said second polymerization state during deposition of said molten metal at a second temperature ranging between about 220° C. and about 800° C., such that the first polymerization state is obtained substantially within about 1 second to about 20 minutes when exposed to said first temperature and the second polymerization state is obtained substantially within about 1 minute to about 30 minutes when exposed to said second temperature, and
wherein the paste composition is self-standing to maintain its deposited production layer shape at least until said first polymerization state is obtained.

2.-5. (canceled)

6. The paste composition of claim 1, wherein the phosphate-based binder is selected from alkali metal trimetaphosphate, alkali metal monophosphate, aluminum phosphates, sodium tripolyphosphate, silico-aluminophosphate, monoaluminium phosphate, polyphosphates, dihydrogen aluminophosphate, polyphosphazene and mixtures thereof.

7. The paste composition of claim 6, wherein the phosphate-based binder is at least one aluminum phosphate.

8. The paste composition of claim 1, wherein said refractory ceramic material is selected from zirconia (ZrO₂), alumina (Al₂O₃), silica (SiO₂), zirconium silicate, yttria-stabilized zirconia, silicon carbide, tungsten carbide, boron nitride, silicon nitride, and mixtures thereof.

9. The paste composition of claim 1, wherein said refractory ceramic material is zirconia (ZrO₂).

10. The paste composition of claim 1, wherein the weight ratio between the refractory ceramic material and the inorganic binder in the paste composition is between about 3:1 and about 35:1.

11. The paste composition of claim 1, wherein said carrier liquid is water.

12. The paste composition of claim 1, having a viscosity of between about 10,000 cps and about 50,000 cps.

13. The paste composition of claim 1, further comprising at least one co-binder.

14. The paste composition of claim 1, further comprising at least one dispersant or at least one surfactant.

15. The paste composition of claim 1, further comprising at least one polymerization inhibitor.

16. The paste composition of claim 1, further comprising at least one thermal shock resistive additive.

17. The paste composition of claim 1, further comprising at least one mechanical reinforcing agent.

18. A paste composition for manufacturing of a mold for additive casting a metal object, in a process of subsequent formation of production layers, each production layer comprising at least one mold region and at least one metal object region, each production layer being manufactured by deposition of said paste composition to form said mold region, drying said mold region, and deposition of molten metal into a cavity defined by the mold region to obtain the metal object region,
each mold region having an object region-facing surface and a subsequent mold region-facing surface,
the paste composition comprising:
between about 55 wt % and about 85 wt % of at least one refractory ceramic material in particulate form;
between about 8 wt % and about 30 wt % of at least one carrier liquid; and
between about 2 wt % and about 12 wt % of at least one inorganic binder having two or more, temperature dependent, polymerization states, a first of said polymerization states being obtained at a lower temperature than a second of said polymerization states,
wherein the particles of the refractory ceramic material and the inorganic binder are dispersed in the carrier liquid thereby providing a paste consistency,
the inorganic binder being selected to undergo polymerization to said first polymerization state during deposition and/or drying of the mold region at a first temperature ranging between about 80° C. and about 200° C., and to said second polymerization state in the subsequent mold region-facing surface during deposition of said molten metal at a second temperature ranging between about 220° C. and about 800° C., such that the first polymerization state is obtained substantially within about 1 second to about 20 minutes when exposed to said first temperature and the second polymerization state is obtained substantially within about 1 minute to about 30 minutes when exposed to said second temperature, and
wherein the paste composition is self-standing to maintain its deposited production layer shape at least until said first polymerization state is obtained.
